(19) United States
(12) Patent Application Publication
(10) Pub. No.: US 2008/0096423 A1
(43) Pub. Date: Apr. 24, 2008

(54) Low voltage differential signaling connector

(76) Inventor: Chun-sen Huang, Shulin City (TW)

Correspondence Address: TROXELL LAW OFFICE PLLC, SUITE 1404, 5205 LEESBURG PIKE, FALLS CHURCH, VA, 22041, US

(21) Appl. No.: 11/583,978

(22) Filed: Oct. 20, 2006

(51) Int. Cl. H01R 13/648

(52) U.S. Cl. 439/608

(57) ABSTRACT

A low voltage differential signaling connector includes a dielectric housing having a mating face, a rear face, an upper face, a lower face and two end faces, a mating slot being defined on the mating face and transversally extending through the rear face and having a plurality of receiving passages and first position slots, the lower face having a plurality of second position slots; a grounding member embedded into the dielectric housing and including an elongated plate, a plurality of first contact arms protruding from the elongated plate and being mounted into the first position slots; a metal shell shielding the dielectric housing and having a plurality of second contact arms corresponding to the second position slots of the dielectric housing; and a plurality of terminals received in the receiving passages of the dielectric housing. Because the grounding member has been separated, the connector can be easily assembled and manufactured.

### BACKGROUND OF THE INVENTION

1. Field of the Invention

The present invention relates to an electrical connector, and particularly to a low voltage differential signaling connector having a separate grounding member, which can simplify structure and processes of manufacturing a metal shell in order to achieve cost benefits.

2. Related Art

The electronic technology has been changing with each passing day, and there are always new electronic products coming out. In order to follow the hi-tech development, traditional through-the-lens (TTL) panels have been developed to low voltage differential signaling (LVDS) panels. LVDS, an electrical signaling system that can transmit large data at very high speeds, is generally adapted for displaying devices of higher resolution than thin film transistor-liquid crystal display of the super video graphics array (TFT-LCD of SVGA), fiber-optic communication, and interfaces for electronic exchange equipments. LVDS, a rather new technique to the electronic technology, can be used with a wide range of integrated circuits with power supply voltages down to 2V, which is lower enough to be applied to hi-tech products in the future. Besides, the low differential voltage of about 330 mV (the lowest of 250 mV and the highest of 450 mV) and swiftly transmitting allow data can be transmitted at speeds from 100 Mbps to above 1 Gbps. LVDS is currently the only interface and scheme that combines low power dissipation with high speed and large bandwidth with lower electromagnetic interference (EMI).

To ensure the data can be transmitted stably at high speed through connectors used for LVDS system, the most important requirement is that the connector has to prevent EMI effectively; Conventional LVDS connector includes a general dielectric housing, multiple terminals, and a metal shell, the metal shell further has numerous grounding terminals corresponding to the multiple terminals for riding the electromagnetic interference. However, the multiple terminals increase difficulties of stamping a model of the metal shell, that is, the stamping involves a complex process and needs more precision and costly stamping machine to work it and which may increase the cost and takes more time on the stamping of the metal shell. Accordingly, how to improve the metal shell by shorten the complex process and cost down is very important.

### SUMMARY OF THE INVENTION

Accordingly, an object of the present invention is to provide a low voltage differential signaling connector, which can be manufactured easily and quickly at lower cost in order to increase the cost benefits.

Another object of the present invention is to provide a low voltage differential signaling connector, which has a separate metal shell with grounding terminals and can be assembled easily.

To achieve the above-mentioned objects, the low voltage differential signaling connector includes a dielectric housing having a mating face, a rear face, an upper face, a lower face and two end faces, a mating slot being defined on the mating face and transversally extending through the rear face, the mating slot having a plurality of receiving passages and first position slots, the lower face having a plurality of second position slots; a grounding member embedded into the dielectric housing and including an elongated plate, a plurality of first contact arms protruding from the elongated plate and being mounted into the first position slots; a metal shell being internally hollow and shielding the dielectric housing, the metal shell having a plurality of second contact arms protruding therefrom and corresponding to the second position slots of the dielectric housing; and a plurality of terminals received in the receiving passages of the dielectric housing.

Other objects, features and advantages of the invention will be apparent from the following detailed description taken in connection with the accompanying drawings.

### BRIEF DESCRIPTION OF THE DRAWINGS

FIG. 1 is an exploded view of a low voltage differential signaling connector of the present invention;

FIG. 2 is an assembled perspective view of FIG. 1 viewed from the front side thereof;

FIG. 3 is an assembled perspective view of FIG. 1 viewed from the rear side thereof;

FIG. 4 is a front elevational view of the present invention;

FIG. 5 is a cross sectional view taken along line 5-5 in FIG. 4;

FIG. 6 is a cross sectional view taken along line 6-6 in FIG. 4 showing a grounding member being engaged with a dielectric housing;

FIG. 7 is a cross sectional view taken along line 7-7 in FIG. 4;

FIG. 8 is a cross sectional view taken along line 8-8 in FIG. 4;

FIG. 9 is a cross sectional view taken along line 9-9 in FIG. 4;

FIG. 10 is a cross sectional view taken along line 10-10 in FIG. 4;

FIG. 11 is a cross sectional view taken along line 11-11 in FIG. 4;

### DESCRIPTION OF THE PREFERRED EMBODIMENTS

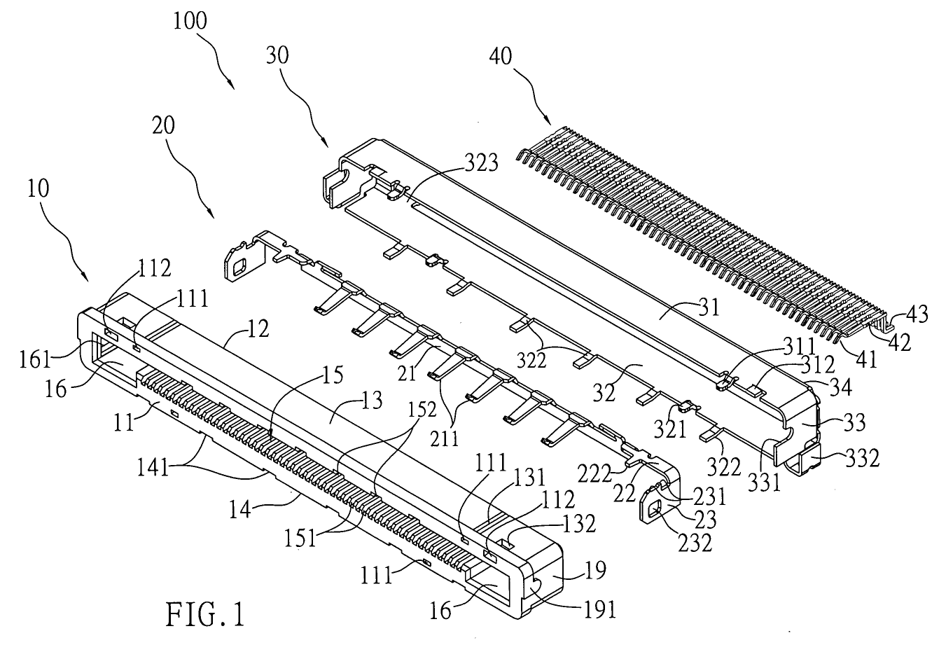

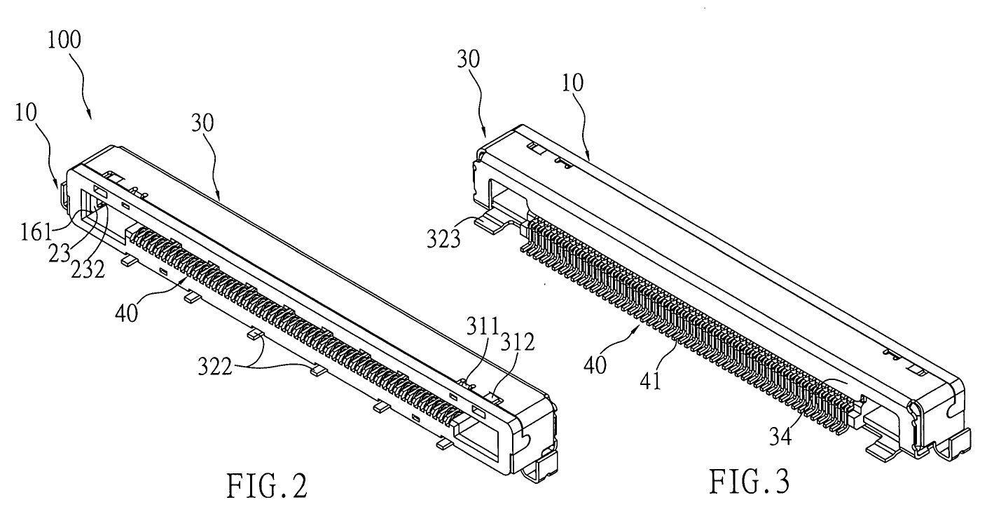

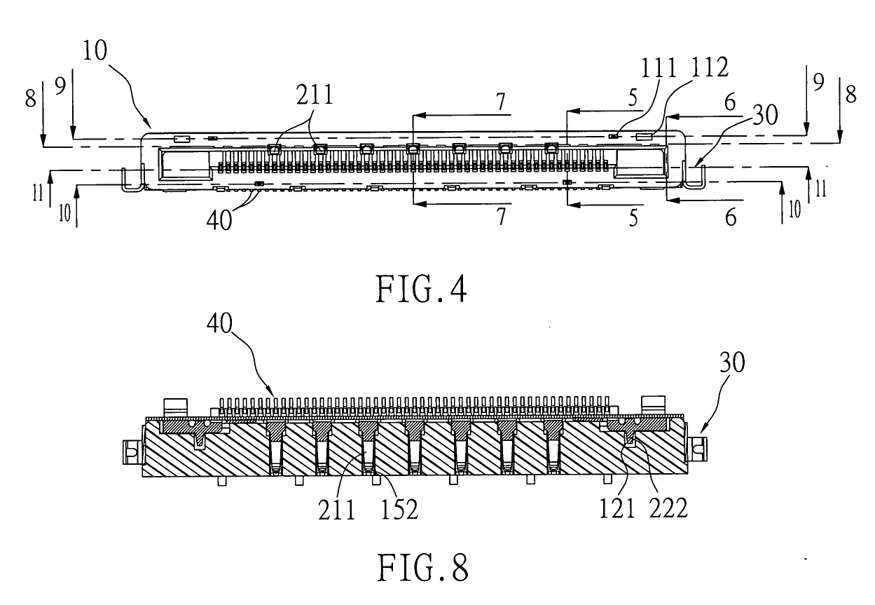

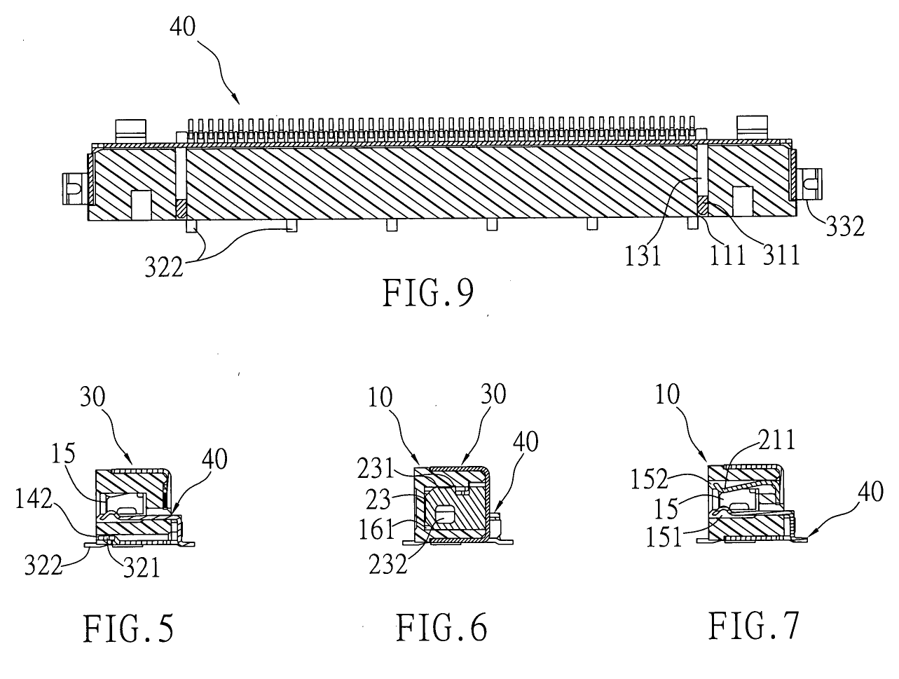

Referring to FIG. 1 to FIG. 5, a low voltage differential signaling connector 100, including a dielectric housing 10, a grounding member 20, a metal shell 30 and a plurality of terminals 40; the dielectric housing 10 has a mating face 11, a rear face 12, an upper face 13, a lower face 14 and two end faces 19, wherein upper and lower sides of the mating face 11 are projecting over the upper and lower faces 13, 14, the mating face 11 having a mating slot 15 which extends transversally through the rear face 12, and defining a retaining portion 16 at opposite ends thereof; the mating slot 15 has a plurality of receiving passages 151 arranged on a lower side thereof and a plurality of first position slots 152 arranged on an upper side thereof; an engaging slot 161 is disposed between the retaining portion 16 and the end face 19; the mating face 11 further has a pair of first locating holes 111 appropriately disposed on an upper and lower sides thereof, respectively; a pair of second locating holes 112 are appropriately disposed near opposite ends of the mating face 11, the second locating holes 112 being larger than the first locating holes 111; each of the first locating holes 111 extends towards the upper face 13 and the lower face 14 to form a channel 131, 142, and each of the second locating holes 112 extends towards the upper face 13 to form a groove 132; the lower face 14 has a plurality of second position slots 141 longitudinally arranged thereon. The opposite end faces 19 respectively have a protrusion 191 protruding therefrom and adjoining the mating face 11. The rear face 12 has a pair of blocking slots 121 corresponding to the locating pegs 222 (described later).

The grounding member 20 being elongated includes an elongated plate 21, a plurality of first contact arms 211 protruding from the elongated plate 21 and being mounted into the first position slots 152; a pair of linking portion 22 bend and extend outwards from opposite ends of the elongated plate 21 respectively, each linking portion 22 having the locating peg 222 laterally extending therefrom towards the dielectric housing 10; a pair of engaging boards 23 extend respectively from one end of each linking portion 22 and correspond to the engaging slots 161 of the dielectric housing 10, each engaging board 23 including a ridge 231 and a locking hole 232 both located thereon, the locking hole 232 used for locking a mating connector (not shown). In assembly, the grounding member 20 is embedded into the dielectric housing 10 from the rear face 12, and then the engaging boards 23 are engaged with the engaging slots 161 (as shown in FIG. 6) through a friction-fit engagement due to the ribs 231; the locating pegs 211 are mounted in the dielectric housing 10 from the blocking slots 121 (as shown in FIG. 8) to provide firmly engagement; in addition, the first contact arms 211 are mounted in the first position slots 152 (as shown in FIGS. 7 and 8) for riding interference signals and EMI.

The metal shell 30 being hollow for shielding the dielectric housing 10 includes an upper wall 31, a lower wall 32, a rear wall 34 and two end walls 33, wherein guiding bars 311, 321 are disposed respectively on the upper wall 31 and the lower wall 32 and correspond to the first locating holes 111; the upper wall 31 has two slats 312 disposed thereon and corresponding to the grooves 132; the lower wall 32 having a plurality of second contact arms 322 protruding therefrom and corresponding to the second position slots 141 of the dielectric housing 10, the lower wall 32 further having a pair of solder plates 323 located on one side opposite to the second contact arms 322, and laterally protruding therefrom; the end walls 33 respectively have a fitting portion 331 corresponding to the protrusions 191, and a solder member 332 extends outwardly from the end wall 33 and perpendicularly bent therefrom.

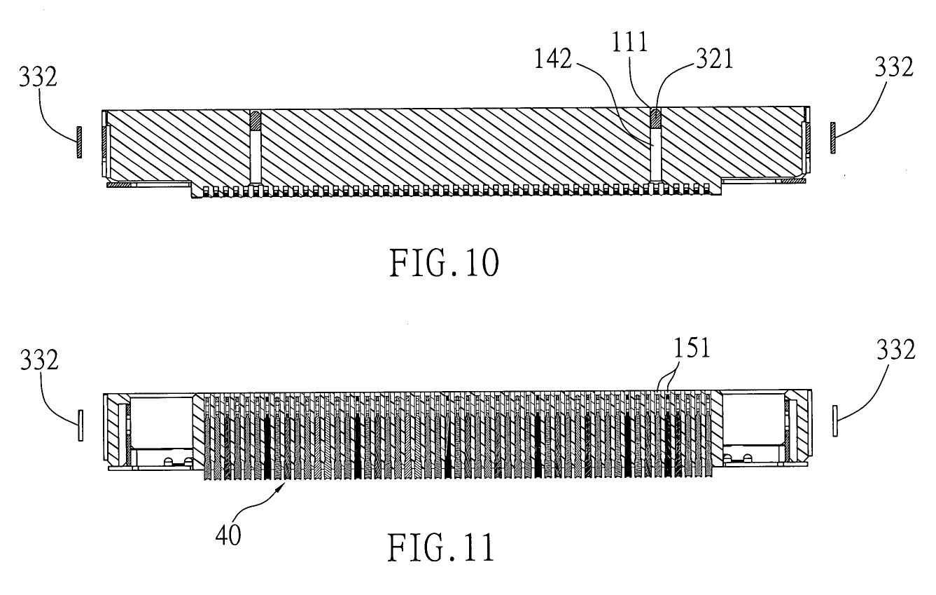

The metal shell 30, in assembly with the dielectric housing 10 as the grounding member 20, shield the dielectric housing 10 from the rear face 12, and the guiding bars 311, 321 are guided from the channels 131, 142 and then engage with the first locating holes 111 (as shown in FIGS. 9 and 10); therefore, the slats 312 are fitted in the grooves 132 to depress the dielectric housing 10 for facilitating the assembly with firmly engagement; furthermore, the second contact arms 322 are mounted in the second position slots 141 for riding interference signals and EMI.

The plurality of terminal 40 are received in the corresponding receiving passages 151 of the dielectric housing 10 (as shown in FIGS. 7 and 11), each of the terminals 40 having a contact part 41 at the front section, an interference part 42 at the middle section, and a solder tail 43 at the rear section thereof; the interference part 42 providing a friction-fit engagement with the receiving passages 151 so that the terminals 40 can be fitted therein.

As the low voltage differential signaling connector 100 has been assembled, the solder plates 323, the solder members 332, the second contact arms 322 of the he metal shell 40, and the solder tails 43 of the terminals 40 are all soldered with surface molding technique (SMT) on a printed circuit board (not shown), and as described above the interference signals or EMI can be released by the first and the second contact arms 211, 311. Consequently, the low voltage differential signaling connector 100 of the present invention with the separate grounding member 20 can simplify structure and processes of manufacturing the metal shell 30 in order to achieve cost benefits.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A low voltage differential signaling connector, comprising:
a dielectric housing having a mating face, a rear face, an upper face, a lower face and two end faces, a mating slot being defined on the mating face and transversally extending through the rear face, the mating slot having a plurality of receiving passages and first position slots both arranged respectively on longitudinal sides thereof, a retaining portion being defined respectively on two ends of the mating slot, an engaging slot disposed between the retaining portion and the end face, the lower face having a plurality of second position slots longitudinally arranged thereon;
a grounding member embedded into the dielectric housing and including an elongated plate, a plurality of first contact arms protruding from the elongated plate and being mounted into the first position slots, a linking portion bending and extending outwards from opposite ends of the elongated plate respectively, an engaging board formed on one end of the linking portion and corresponding to the engaging slot, the engaging board including a ridge and a locking hole both located thereon;
a metal shell being hollow for shielding the dielectric housing and including an upper wall and a lower wall, the lower wall having a plurality of second contact arms protruding therefrom and corresponding to the second position slots of the dielectric housing; and
a plurality of terminals received in the receiving passages of the dielectric housing.

2. The low voltage differential signaling connector as claimed in claim 1, wherein the engaging board bends downwardly from the dielectric housing and extends forward to the engaging slot.

3. The low voltage differential signaling connector as claimed in claim 1, wherein the mating face has at least a first locating hole disposed on an upper or a lower side thereof, the first locating hole extending towards the upper face or the lower face to form a channel.

4. The low voltage differential signaling connector as claimed in claim 1, wherein the mating face further has at least a second locating hole disposed near an end thereof, the second locating hole extending towards the upper face to form a groove.

5. The low voltage differential signaling connector as claimed in claim 1, wherein the end face of the dielectric housing has a protrusion protruding therefrom and adjoining the mating face.

6. The low voltage differential signaling connector as claimed in claim 5, wherein the metal shell further has a pair of opposite end walls, each end wall has a fitting portion corresponding to the protrusion, and a solder member extending outwardly from the end wall and perpendicularly bent therefrom.

7. The low voltage differential signaling connector as claimed in claim 1, wherein the linking portion further has a locating peg laterally extending therefrom towards the dielectric housing.

8. The low voltage differential signaling connector as claimed in claim 6, wherein the rear face of the dielectric housing has a blocking slot corresponding to the locating peg.

9. The low voltage differential signaling connector as claimed in claim 3, wherein a guiding bar is disposed respectively on the upper wall and the lower wall and corresponds to the first locating hole.

10. The low voltage differential signaling connector as claimed in claim 4, wherein the upper wall of the metal shell has a slat disposed thereon and corresponding to the groove.

11. The low voltage differential signaling connector as claimed in claim 9, wherein the lower wall of the metal shell further has a solder plate located on one side opposite to the second contact arm, the solder plate laterally protruding therefrom.

12. The low voltage differential signaling connector as claimed in claim 1, wherein each of the terminals has a contact part at the front section, an interference part at the middle section, and a solder tail at the rear section thereof.

13. The low voltage differential signaling connector as claimed in claim 1, wherein upper and lower sides of the mating face are projecting over the upper and lower faces of the dielectric housing.

14. A low voltage differential signaling connector, comprising:
a dielectric housing having a mating face, a rear face, an upper face, a lower face and two end faces, a mating slot being defined on the mating face and transversally extending through the rear face, the mating slot having a plurality of receiving passages and first position slots both disposed respectively on longitudinal sides thereof, the lower face having a plurality of second position slots longitudinally arranged thereon;
a grounding member embedded into the dielectric housing and including a elongated plate, a plurality of first contact arms protruding from the elongated plate and being mounted into the first position slots;
a metal shell being hollow for shielding the dielectric housing and including an upper wall and a lower wall, the lower wall having a plurality of second contact arms protruding therefrom and corresponding to the second position slots of the dielectric housing; and
a plurality of terminals received in the receiving passages of the dielectric housing.
